(19) United States
(12) Patent Application Publication
(10) Pub. No.: US 2023/0214589 A1
(43) Pub. Date: Jul. 6, 2023

(54) Dynamic Chat Discourse Rephrasing

(71) Applicant: International Business Machines Corporation, Armonk, NY (US)

(72) Inventors: Mary Diane Swift, Rochester, NY (US); Irene Lizeth Manotas Gutiérrez, White Plains, NY (US); Kelley Anders, East New Market, MD (US); Jonathan D. Dunne, Dungarvan (IE); Qi Li, BEIJING (CN)

(21) Appl. No.: 17/646,881

(22) Filed: Jan. 4, 2022

(51) Int. Cl. G06F 40/253; H04L 51/046; G06N 20/00

(52) U.S. Cl. CPC G06F 40/253; H04L 51/046; G06N 20/00

(57) ABSTRACT

Dynamic chat discourse rephrasing is provided. An analysis is performed of a real-time chat discourse conducted between a plurality of users connected via a network. A discourse comprehension model is generated based on the analysis of the real-time chat discourse. A set of text is rephrased in the real-time chat discourse to decrease user time to comprehend the set of text using the discourse comprehension model.

### BACKGROUND

### 1. Field

The disclosure relates generally to chat discourses and more specifically to applying a discourse comprehension model to text of a real-time chat discourse to rephrase a set of the text during the real-time chat discourse for decreased time-based user readability and increased user comprehension of the rephrased set of text by a particular user or group of users currently participating in the real-time chat discourse.

### 2. Description of the Related Art

A chat discourse is a form of computer-mediated communication performed by exchanging text-based messages in real-time or synchronously via a computer network, such as, for example, the Internet. Communication develops as a user sends text to another user or group of users connected via computers at the same time. Divergence in chat discourses may occur in terms of, for example, formality, text construction, topic, subject matter, misinterpretation, and the like.

### SUMMARY

According to one illustrative embodiment, a computer-implemented method for dynamic chat discourse rephrasing is provided. A computer performs an analysis of a real-time chat discourse conducted between a plurality of users connected via a network. The computer generates a discourse comprehension model based on the analysis of the real-time chat discourse. The computer rephrases a set of text in the real-time chat discourse to decrease user time to comprehend the set of text using the discourse comprehension model. According to other illustrative embodiments, a computer system and computer program product for dynamic chat discourse rephrasing are provided.

### BRIEF DESCRIPTION OF THE DRAWINGS

FIG. 1 is a pictorial representation of a network of data processing systems in which illustrative embodiments may be implemented;

FIG. 2 is a diagram of a data processing system in which illustrative embodiments may be implemented;

FIG. 3 is a diagram illustrating an example of a chat discourse analysis process in accordance with an illustrative embodiment;

FIG. 4 is a diagram illustrating an example of a discourse comprehension model generation process in accordance with an illustrative embodiment;

FIG. 5 is a diagram illustrating an example of a chat discourse rephrasing process in accordance with an illustrative embodiment;

FIG. 6 is a flowchart illustrating a process for a discourse comprehension model in accordance with an illustrative embodiment; and

FIG. 7 is a flowchart illustrating a process for dynamic chat discourse rephrasing in accordance with an illustrative embodiment.

### DETAILED DESCRIPTION

The present invention may be a system, a method, and/or a computer program product at any possible technical detail level of integration. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

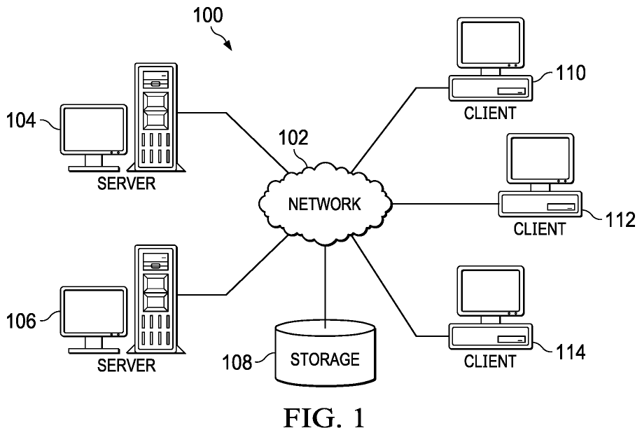

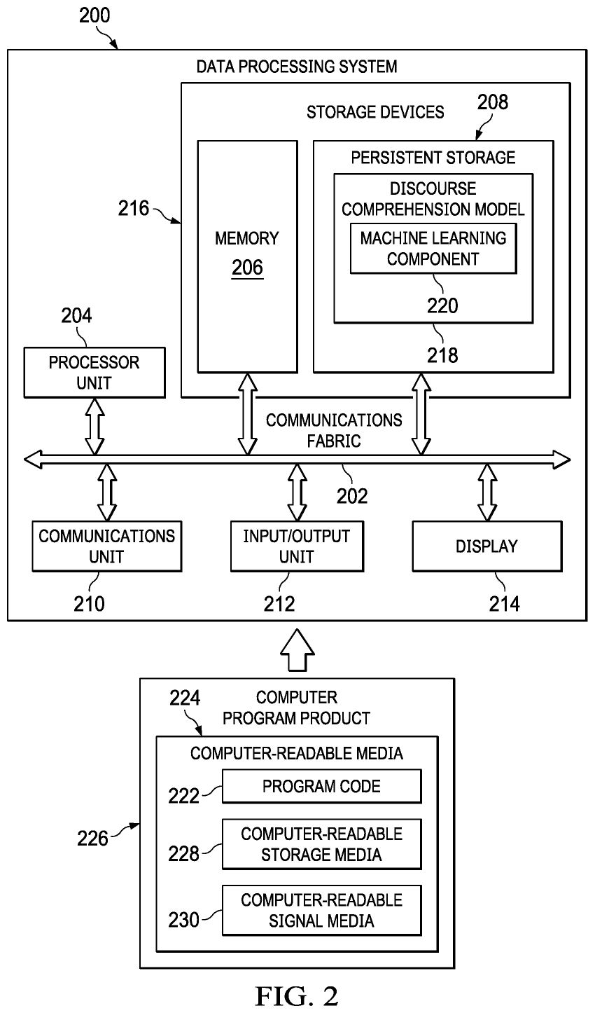

With reference now to the figures, and in particular, with reference to FIG. 1 and FIG. 2, diagrams of data processing environments are provided in which illustrative embodiments may be implemented. It should be appreciated that FIG. 1 and FIG. 2 are only meant as examples and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers, data processing systems, and other devices in which the illustrative embodiments may be implemented. Network data processing system 100 contains network 102, which is the medium used to provide communications links between the computers, data processing systems, and other devices connected together within network data processing system 100. Network 102 may include connections, such as, for example, wire communication links, wireless communication links, fiber optic cables, and the like.

In the depicted example, server 104 and server 106 connect to network 102, along with storage 108. Server 104 and server 106 may be, for example, server computers with high-speed connections to network 102. Also, server 104 and server 106 may each represent a cluster of servers in one or more data centers. Alternatively, server 104 and server 106 may each represent multiple computing nodes in one or more cloud environments.

In addition, server 104 and server 106 may provide a set of chat discourse services to client device users. Further, server 104 and server 106 can perform dynamic chat discourse rephrasing. For example, server 104 and server 106 can generate and apply a discourse comprehension model to text of a real-time chat discourse to rephrase a set of the text during the real-time chat discourse for decreased time-based user readability and increased user comprehension of the rephrased set of text by a particular user or group of users currently participating in the real-time chat discourse. The discourse comprehension model rephrases a chat utterance relative to a level of comprehension by one or more chat discourse participants. Server 104 and server 106 can apply the discourse comprehension model to any type of chat utterance, such as, for example, posed questions and provided answers during the chat discourse.

Server 104 and server 106 utilize comprehension gradient analysis on the text of the chat discourse, along with corpus linguistic analysis, topic modeling analysis, and readability analysis, to rephrase certain portions of the text to decrease complexity and make those portions of the text easier to read and understand by a given user or group of users in general or specific to a particular topic. Comprehension gradient analysis using linguistic features of the text in the chat discourse increases user readability and understandability of the text to improve communication (e.g., interpretation of the text by chat discourse participants). For example, by analyzing characteristics of students using, for example, student profiles, server 104 and server 106 can tailor text specific to the needs of the students to optimize student learning. For a chatbot, server 104 and server 106 can adjust text so that a user having certain characteristics can easily understand the text provided by that chatbot. Thus, server 104 and server 106 are capable of analyzing text according to different characteristics of a particular user or group of users to rephrase or adapt the text according to the level of comprehension for that particular user or group of users for enhanced communication.

Client 110, client 112, and client 114 also connect to network 102. Clients 110, 112, and 114 are client devices of server 104 and server 106. In this example, clients 110, 112, and 114 are shown as desktop or personal computers with wire communication links to network 102. However, it should be noted that clients 110, 112, and 114 are examples only and may represent other types of data processing systems, such as, for example, network computers, laptop computers, handheld computers, smart phones, smart televisions, smart vehicles, gaming devices, kiosks, and the like, with wire or wireless communication links to network 102. Users of clients 110, 112, and 114 may utilize clients 110, 112, and 114 to access and utilize the chat discourse services provided by server 104 and server 106.

Storage 108 is a network storage device capable of storing any type of data in a structured format or an unstructured format. In addition, storage 108 may represent a plurality of network storage devices. Further, storage 108 may store identifiers and network addresses for a plurality of client devices, identifiers for a plurality of client device users, user profiles corresponding to the plurality of client device users, chat discourse histories corresponding to the plurality of client device users, discourse comprehension models, and the like. Furthermore, storage 108 may store other types of data, such as authentication or credential data that may include usernames, passwords, and the like associated with, for example, client device users and system administrators.

In addition, it should be noted that network data processing system 100 may include any number of additional servers, clients, storage devices, and other devices not shown. Program code located in network data processing system 100 may be stored on a computer-readable storage medium or a set of computer-readable storage media and downloaded to a computer or other data processing device for use. For example, program code may be stored on a computer-readable storage medium on server 104 and downloaded to client 110 over network 102 for use on client 110.

In the depicted example, network data processing system 100 may be implemented as a number of different types of communication networks, such as, for example, an internet, an intranet, a wide area network, a local area network, a telecommunications network, or any combination thereof. FIG. 1 is intended as an example only, and not as an architectural limitation for the different illustrative embodiments.

As used herein, when used with reference to items, “a number of” means one or more of the items. For example, “a number of” different types of “communication networks” is one or more different types of communication networks. Similarly, “a set of,” when used with reference to items, means one or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

With reference now to FIG. 2, a diagram of a data processing system is depicted in accordance with an illustrative embodiment. Data processing system 200 is an example of a computer, such as server 104 in FIG. 1, in which computer-readable program code or instructions implementing the dynamic chat discourse rephrasing processes of illustrative embodiments may be located. In this example, data processing system 200 includes communications fabric 202, which provides communications between processor unit 204, memory 206, persistent storage 208, communications unit 210, input/output unit 212, and display 214.

Processor unit 204 serves to execute instructions for software applications and programs that may be loaded into memory 206. Processor unit 204 may be a set of one or more hardware processor devices or may be a multi-core processor, depending on the particular implementation.

Memory 206 and persistent storage 208 are examples of storage devices 216. As used herein, a computer-readable storage device or a computer-readable storage medium is any piece of hardware that is capable of storing information, such as, for example, without limitation, data, computer-readable program code in functional form, and/or other suitable information either on a transient basis or a persistent basis. Further, a computer-readable storage device or a computer-readable storage medium excludes a propagation medium, such as transitory signals. Furthermore, a computer-readable storage device or a computer-readable storage medium may represent a set of computer-readable storage devices or a set of computer-readable storage media. Memory 206, in these examples, may be, for example, a random-access memory, or any other suitable volatile or non-volatile storage device, such as a flash memory. Persistent storage 208 may take various forms, depending on the particular implementation. For example, persistent storage 208 may contain one or more devices. For example, persistent storage 208 may be a disk drive, a solid-state drive, a rewritable optical disk, a rewritable magnetic tape, or some combination of the above. The media used by persistent storage 208 may be removable. For example, a removable hard drive may be used for persistent storage 208.

In this example, persistent storage 208 stores discourse comprehension model 218. However, it should be noted that even though discourse comprehension model 218 is illustrated as residing in persistent storage 208, in an alternative illustrative embodiment, discourse comprehension model 218 may be a separate component of data processing system 200. For example, discourse comprehension model 218 may be a hardware component coupled to communication fabric 202 or a combination of hardware and software components. In another alternative illustrative embodiment, a first set of components of discourse comprehension model 218 may be located in data processing system 200 and a second set of components of discourse comprehension model 218 may be located in a second data processing system, such as, for example, server 106 in FIG. 1.

Discourse comprehension model 218 controls the process of dynamically rephrasing text in a real-time chat discourse by replacing complex, scientific, or difficult to understand words in a sentence with basic, fundamental, or easy to understand words, which are related to the current topic of discussion, or by rearranging words in the sentence to decrease or flatten a gradient of user comprehension, which indicates an increase in user readability and an increase in user comprehension of the rephrased text by a user or group of users currently participating in the real-time chat discourse. In this example, discourse comprehension model 218 includes machine learning component 220. However, in an alternative illustrative embodiment, machine learning component 220 can be a separate or stand-alone component of data processing system 200.

Machine learning component 220 fine-tunes, adjusts, or customizes discourse comprehension model 218 over time. For example, machine learning component 220 involves inputting data to the process and allowing the process to adjust and improve the predictive accuracy and functionality of discourse comprehension model 218 over time, thereby increasing the performance of data processing system 200, itself.

Machine learning component 220 can learn without being explicitly programmed to do so. Machine learning component 220 can learn based on training data (e.g., historical chat discourse data involving a plurality of different users) input into machine learning component 220. Machine learning component 220 can learn using various types of machine learning algorithms. The various types of machine learning algorithms may include at least one of supervised learning, semi-supervised learning, unsupervised learning, reinforcement learning, feature learning, sparse dictionary learning, anomaly detection, association rules, or other types of learning algorithms. Examples of machine learning models include an artificial neural network, a decision tree, a support vector machine, a Bayesian network, a genetic algorithm, and other types of models.

Machine learning component 220 can customize discourse comprehension model 218 on a per chat discourse channel and temporal basis. In other words, machine learning component 220 can customize discourse comprehension model 218 on a specific chat discourse channel, such as, for example, a software development channel, over a relative measurement of time. Thus, discourse comprehension model 218 is capable of rephasing chat discourse text in a style that is easier to understand by a specific user or group of users discussing a particular topic on a particular chat discourse channel.

As a result, data processing system 200 operates as a special purpose computer system in which discourse comprehension model 218 in data processing system 200 enables the automatic rephrasing of text during a real-time chat discourse to increase user readability and understanding of that text. In particular, discourse comprehension model 218 transforms data processing system 200 into a special purpose computer system as compared to currently available general computer systems that do not have discourse comprehension model 218.

Communications unit 210, in this example, provides for communication with other computers, data processing systems, and devices via a network, such as network 102 in FIG. 1. Communications unit 210 may provide communications through the use of both physical and wireless communications links. The physical communications link may utilize, for example, a wire, cable, universal serial bus, or any other physical technology to establish a physical communications link for data processing system 200. The wireless communications link may utilize, for example, shortwave, high frequency, ultrahigh frequency, microwave, wireless fidelity (Wi-Fi), Bluetooth® technology, global system for mobile communications (GSM), code division multiple access (CDMA), second-generation (2G), third-generation (3G), fourth-generation (4G), 4G Long Term Evolution (LTE), LTE Advanced, fifth-generation (5G), or any other wireless communication technology or standard to establish a wireless communications link for data processing system 200.

Input/output unit 212 allows for the input and output of data with other devices that may be connected to data processing system 200. For example, input/output unit 212 may provide a connection for user input through a keypad, a keyboard, a mouse, a microphone, and/or some other suitable input device. Display 214 provides a mechanism to display information to a user and may include touch screen capabilities to allow the user to make on-screen selections through user interfaces or input data, for example.

Instructions for the operating system, applications, and/or programs may be located in storage devices 216, which are in communication with processor unit 204 through communications fabric 202. In this illustrative example, the instructions are in a functional form on persistent storage 208. These instructions may be loaded into memory 206 for running by processor unit 204. The processes of the different embodiments may be performed by processor unit 204 using computer-implemented instructions, which may be located in a memory, such as memory 206. These program instructions are referred to as program code, computer usable program code, or computer-readable program code that may be read and run by a processor in processor unit 204. The program instructions, in the different embodiments, may be embodied on different physical computer-readable storage devices, such as memory 206 or persistent storage 208.

Program code 222 is located in a functional form on computer-readable media 224 that is selectively removable and may be loaded onto or transferred to data processing system 200 for running by processor unit 204. Program code 222 and computer-readable media 224 form computer program product 226. In one example, computer-readable media 224 may be computer-readable storage media 228 or computer-readable signal media 230.

In these illustrative examples, computer-readable storage media 228 is a physical or tangible storage device used to store program code 222 rather than a medium that propagates or transmits program code 222. Computer-readable storage media 228 may include, for example, an optical or magnetic disc that is inserted or placed into a drive or other device that is part of persistent storage 208 for transfer onto a storage device, such as a hard drive, that is part of persistent storage 208. Computer-readable storage media 228 also may take the form of a persistent storage, such as a hard drive, a thumb drive, or a flash memory that is connected to data processing system 200.

Alternatively, program code 222 may be transferred to data processing system 200 using computer-readable signal media 230. Computer-readable signal media 230 may be, for example, a propagated data signal containing program code 222. For example, computer-readable signal media 230 may be an electromagnetic signal, an optical signal, or any other suitable type of signal. These signals may be transmitted over communication links, such as wireless communication links, an optical fiber cable, a coaxial cable, a wire, or any other suitable type of communications link.

Further, as used herein, “computer-readable media 224” can be singular or plural. For example, program code 222 can be located in computer-readable media 224 in the form of a single storage device or system. In another example, program code 222 can be located in computer-readable media 224 that is distributed in multiple data processing systems. In other words, some instructions in program code 222 can be located in one data processing system while other instructions in program code 222 can be located in one or more other data processing systems. For example, a portion of program code 222 can be located in computer-readable media 224 in a server computer while another portion of program code 222 can be located in computer-readable media 224 located in a set of client computers.

The different components illustrated for data processing system 200 are not meant to provide architectural limitations to the manner in which different embodiments can be implemented. In some illustrative examples, one or more of the components may be incorporated in or otherwise form a portion of, another component. For example, memory 206, or portions thereof, may be incorporated in processor unit 204 in some illustrative examples. The different illustrative embodiments can be implemented in a data processing system including components in addition to or in place of those illustrated for data processing system 200. Other components shown in FIG. 2 can be varied from the illustrative examples shown. The different embodiments can be implemented using any hardware device or system capable of running program code 222.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system.

Today, it is common for people to communicate with each other using various Internet-based chat discourse systems, such as, for example, chat rooms, social media websites or platforms, instant messaging systems, web logs, online bulletin boards, and the like. It is also common that some posted messages during a chat discourse are misinterpreted or difficult to understand by a reader due to, for example, complexity of wording in a post, unfamiliarity of wording in a post, sentence structure, punctuation usage, slang usage, and the like. Users of these Internet-based chat discourse systems need a clear and comprehensible way to communicate with each other. If a message is hard for a reader to understand, then typically the sender will try to rephrase the message and then resend. For example, the sender can adjust the position of one or more specific words or sentences in a message to clarify text of a previously sent message.

Illustrative embodiments can automatically rephrase text in a chat discourse when illustrative embodiments determine that a change in the text is needed for greater user readability and understanding. Illustrative embodiments generate a discourse comprehension model to rephrase the text in the chat discourse to decrease user reading time and increase user comprehension of the text. The discourse comprehension model performs dynamic adjustment of the sequence of words or sentences in the text, which results in a clearer and more comprehensible communication during the chat discourse.

Illustrative embodiments perform corpus linguistic analysis and comprehension gradient analysis (e.g., Lebesgue integration) on the text of the chat discourse. Illustrative embodiments also perform an analysis of user profiles corresponding to users participating in the chat discourse and history of chat discourses previously conducted between those users. Based on the linguistic analysis, the comprehensive gradient analysis, the user profile analysis, and the chat discourse history analysis, illustrative embodiments generate the discourse comprehension model for the chat discourse between the users. It should be noted that the discourse comprehension model can include a machine learning component, which utilizes, for example, at least one of supervised learning, semi-supervised learning, unsupervised learning, reinforcement learning, or the like. Illustrative embodiments utilize the discourse comprehension model to dynamically rephrase a set of text in the chat discourse to increase user comprehension (e.g., decrease user time to respond to a message). Illustrative embodiments also rephrase the text to make the text sound natural for that user to send to another user. As a result, illustrative embodiments maintain the semantics and style of the original text of the user.

Illustrative embodiments can customize the discourse comprehension model on a per channel and temporal basis. In other words, illustrative embodiments can customize the discourse comprehension model to a specific channel, such as, for example, a data science channel, a DevOps channel, an engineering channel, a social network channel, or the like, over time using the machine learning component. As a result, illustrative embodiments are capable of generating a discourse comprehension model that considers the preferred and easier to understand chat discourse text (e.g., best suited linguistic style) for a specific user or group of users.

The discourse comprehension model can also provide a predetermined number (e.g., 3) of top alternative rephrased text for the user to select user-preferred text for a particular chat discourse. Illustrative embodiments can use the machine learning component to evaluate and adjust the discourse comprehension model based on chat discourse dialog dynamics by taking into account whether or not rephrased text improves communication flow during the chat discourse (e.g., whether the number of follow up messages regarding clarifications or questions is reduced after text rephrasing, whether the number of similar messages in the chat discourse is reduced after text rephrasing, or some other indication as to whether the rephrased text was easier to read and understand by other users during the chat discourse).

Further, in response to the discourse comprehension model identifying, for example, that a particular user typically communicates using analogies to nature based on analyzing information contained in a user profile corresponding to that particular user and a history of past chat discourses of that particular user, then the discourse comprehension model can rephrase text authored by that particular user during a chat discourse by taking into account analogies to nature. Furthermore, the discourse comprehension model can generate in a graphical user interface a visualization, such as, for example, a heatmap, as a measure of user readability and comprehension of the current chat discourse as compared to user readability and comprehension of similar chat discourses. Moreover, the discourse comprehension model can fine-tune user comprehension time of text by predicting a likelihood that a particular user is multi-tasking or interrupted during the chat discourse based on analyzing text, such as, for example, “please hold”, “back momentarily”, “need to take a call”, or the like, posted by that particular user during the chat discourse.

As a result, illustrative embodiments provide one or more technical solutions that overcome a technical problem with lack of user understanding during synchronous text-based communications via a network. As a result, these one or more technical solutions provide a technical effect and practical application in the field of real-time Internet-based communications.

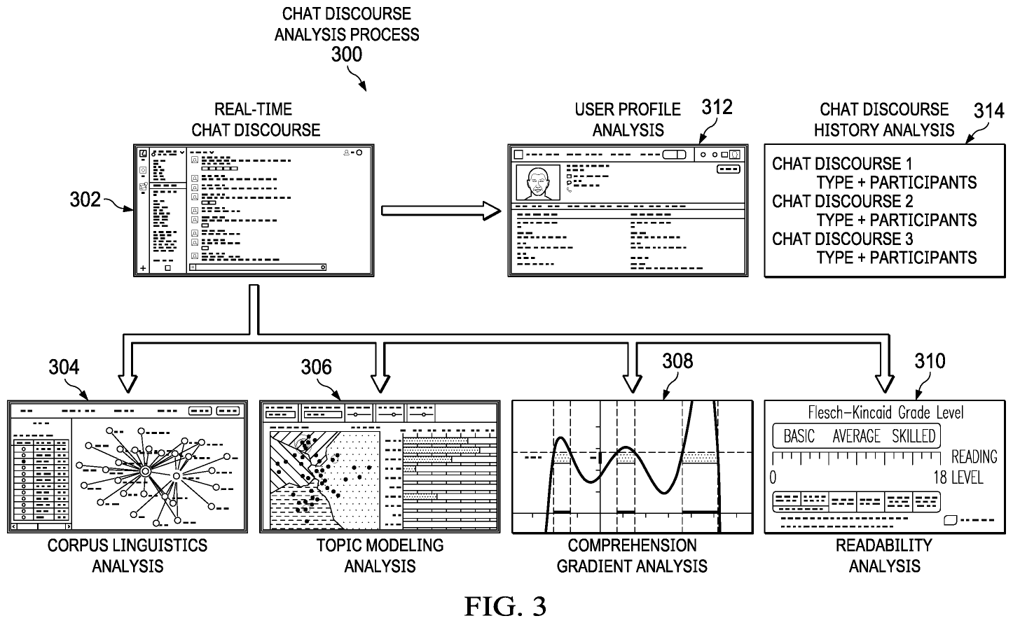

With reference now to FIG. 3, a diagram illustrating an example of a chat discourse analysis process is depicted in accordance with an illustrative embodiment. Chat discourse analysis process 300 may be implemented in a computer, such as, for example, server 104 in FIG. 1 or data processing system 200 in FIG. 2.

In this example, chat discourse analysis process 300 analyzes real-time chat discourse 302. Real-time chat discourse 302 may represent any type of chat discourse (e.g., instant messages, chat room posts, social media posts, or the like) regarding any topic or subject matter. In addition, real-time chat discourse 302 can include any number of participants (e.g., two or more). During real-time chat discourse 302, the participants exchange chat utterances (e.g., textual messages).

Chat discourse analysis process 300 analyzes real-time chat discourse 302 using corpus linguistics analysis 304, topic modeling analysis 306, comprehension gradient analysis 308, and readability analysis 310. Chat discourse analysis process 300 utilizes corpus linguistics analysis 304 to determine linguistic patterns (e.g., word frequencies, word patterns, word collocations, and the like) within real-time chat discourse 302. Corpus linguistics is a computer-aided analysis of natural language as expressed in a body of text. Chat discourse analysis process 300 utilizes topic modeling analysis 306 to determine a set of topics being discussed in real-time chat discourse 302. Topic modeling is a type of statistical analysis using text mining to discover topics that occur in a body of text (e.g., grouping words that correspond to a particular topic). Chat discourse analysis process 300 utilizes comprehension gradient analysis 308 to determine a gradient or measure (e.g., a graph) of user comprehension regarding text (e.g., time to comprehend words and sentences) used in real-time chat discourse 302. Chat discourse analysis process 300 utilizes readability analysis 310 to determine a level of user readability of text in real-time chat discourse 302 (e.g., generate a numeric score for text readability). Readability refers to the ease in which text can be understood by a reader. Readability metrics, such as, for example, Flesch-Kincaid Grade Level Readability Calculator and Gunning Fog Index are algorithmic heuristics used for estimating readability.

Further, chat discourse analysis process 300 utilizes user profile analysis 312 and chat discourse history analysis 314 to further analyze real-time chat discourse 302. Chat discourse analysis process 300 utilizes user profile analysis 312 to analyze user profiles corresponding to the plurality of users participating in real-time chat discourse 302. A user profile may contain, for example, user education level, user job title, user years of experience, user expertise level regarding a particular subject or subjects, user preferences regarding word usage, user writing style (e.g., formal, informal, expository, narrative, or the like), dictionary of preferred terms (e.g., basic, fundamental, or common terms) corresponding to a set of topics, and the like. Chat discourse analysis process 300 utilizes chat discourse history analysis 314 to identify the number and types of chat discourses previously conducted by each respective user and with whom. It should be noted that the user profiles may also contain the chat discourse histories of the users participating real-time chat discourse 302.

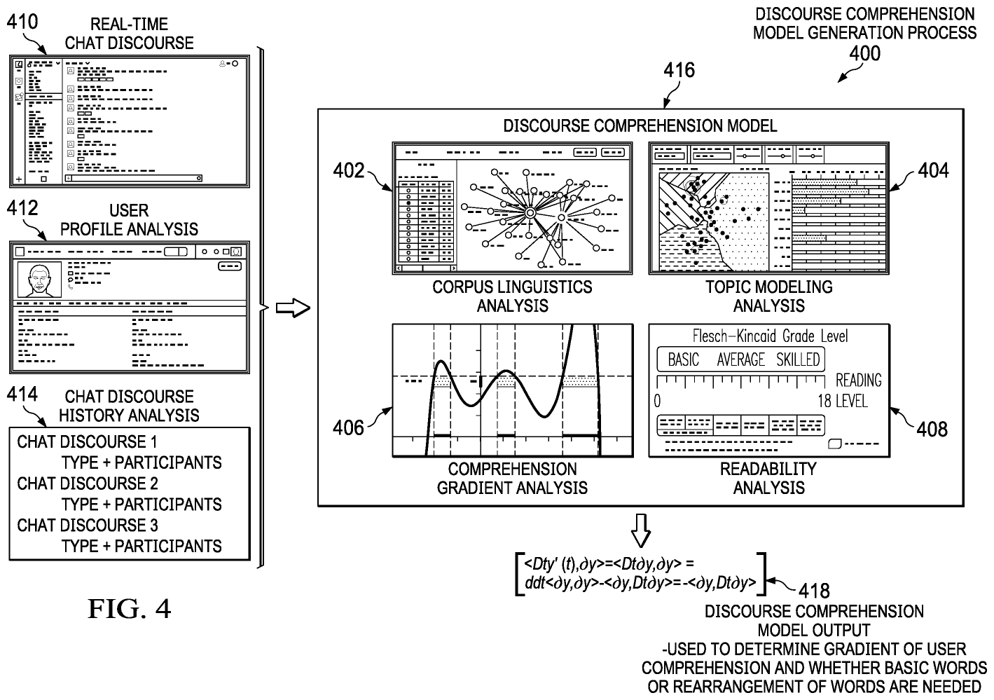

With reference now to FIG. 4, a diagram illustrating an example of a discourse comprehension model generation process is depicted in accordance with an illustrative embodiment. Discourse comprehension model generation process 400 may be implemented in a computer, such as, for example, server 104 in FIG. 1 or data processing system 200 in FIG. 2.

In this example, discourse comprehension model generation process 400 utilizes corpus linguistic analysis 402, topic modeling analysis 404, comprehension gradient analysis 406, and readability analysis 408 of real-time chat discourse 410, along with user profile analysis 412 and chat discourse history analysis 414, to generate discourse comprehension model 416 for real-time chat discourse 410. Real-time chat discourse 410 may be, for example, real-time chat discourse 302 in FIG. 3. Corpus linguistic analysis 402, topic modeling analysis 404, comprehension gradient analysis 406, and readability analysis 408 may be, for example, corpus linguistic analysis 304, topic modeling analysis 306, comprehension gradient analysis 308, and readability analysis 310 in FIG. 3. Discourse comprehension model 416 may be, for example, discourse comprehension model 218 in FIG. 2.

In this example, discourse comprehension model 416 generates discourse comprehension model output 418 based on analysis of text in real-time chat discourse 410. Discourse comprehension model 416 utilizes discourse comprehension model output 418 to determine gradient of user comprehension and whether basic words or rearrangement of words are needed. For example, if discourse comprehension model 416 determines that the gradient of user comprehension is greater than a defined gradient threshold level, then discourse comprehension model 416 determines that rephrasing of text in real-time chat discourse 410 is needed using at least one of basic words or rearrangement of words in the text to flatten the gradient of user comprehension to increase user readability and comprehension of the text. It should be noted that a machine learning component, such as, for example, machine learning component 220 in FIG. 2, can automatically adjust the defined gradient threshold level over time as needed.

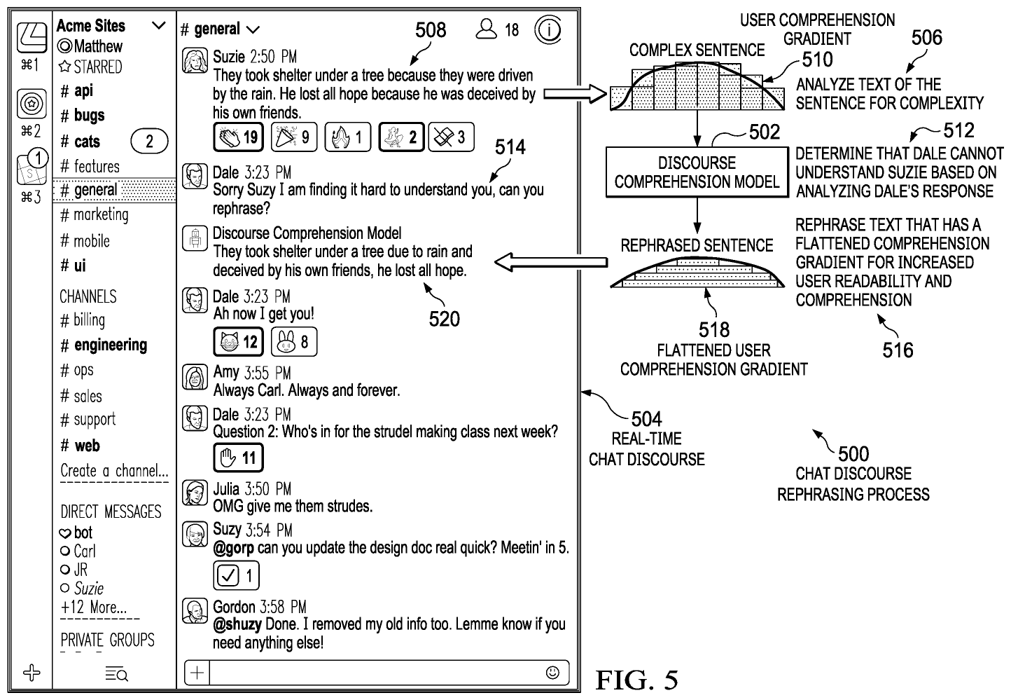

With reference now to FIG. 5, a diagram illustrating an example of a chat discourse rephrasing process is depicted in accordance with an illustrative embodiment. Chat discourse rephrasing process 500 may be implemented in a computer, such as, for example, server 104 in FIG. 1 or data processing system 200 in FIG. 2.

In this example, chat discourse rephrasing process 500 is implemented in discourse comprehension model 502, such as, for example, discourse comprehension model 416 in FIG. 4. Chat discourse rephrasing process 500 applies discourse comprehension model 502 to real-time chat discourse 504, such as, for example, real-time chat discourse 410 in FIG. 4.

At 506, discourse comprehension model 502 analyzes text of sentence 508 posted by Suzie for complexity. Based on the analysis of the text of sentence 508, discourse comprehension model 502 generates user comprehension gradient 510, which indicates that sentence 508 is a complex sentence. At 512, discourse comprehension model 502 determines that Dale cannot understand Suzie based on analyzing response 514 posted by Dale. At 516, discourse comprehension model 502 rephrases text of sentence 508 to produce a simplified, rephrased sentence having flattened user comprehension gradient 518 for increased user readability and comprehension. At 520, discourse comprehension model 502 posts the rephrased sentence in real-time chat discourse 504. As a result, Dale is now able to understand the rephrasing of sentence 508.

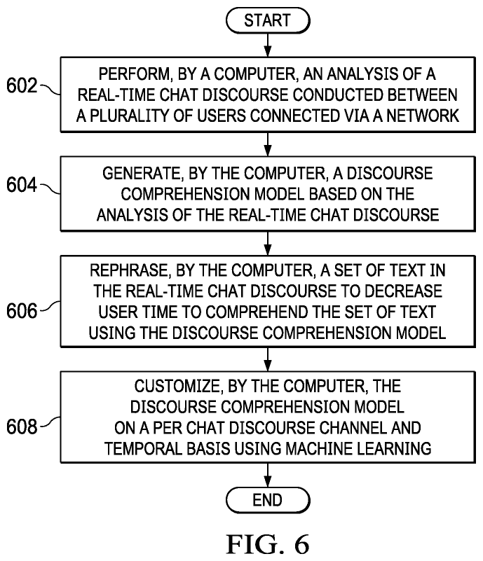

With reference now to FIG. 6, a flowchart illustrating a process for a discourse comprehension model is shown in accordance with an illustrative embodiment. The process shown in FIG. 6 may be implemented in a computer, such as, for example, server 104 in FIG. 1 or data processing system 200 in FIG. 2.

The process begins when the computer performs an analysis of a real-time chat discourse conducted between a plurality of users connected via a network (step 602). The computer generates a discourse comprehension model based on the analysis of the real-time chat discourse (step 604). The computer rephrases a set of text in the real-time chat discourse to decrease user time to comprehend the set of text using the discourse comprehension model (step 606). The computer dynamically rephrases the set of text in the real-time chat discourse on at least one of a per chat discourse channel basis or a per chat discourse user group basis. In addition, the computer can also dynamically rephrase the set of text in the real-time chat discourse in accordance with a style used by the plurality of users to decrease complexity and increase user readability and understanding. Further, the computer customizes the discourse comprehension model on a per chat discourse channel and temporal basis using machine learning (step 608). Thereafter, the process terminates.

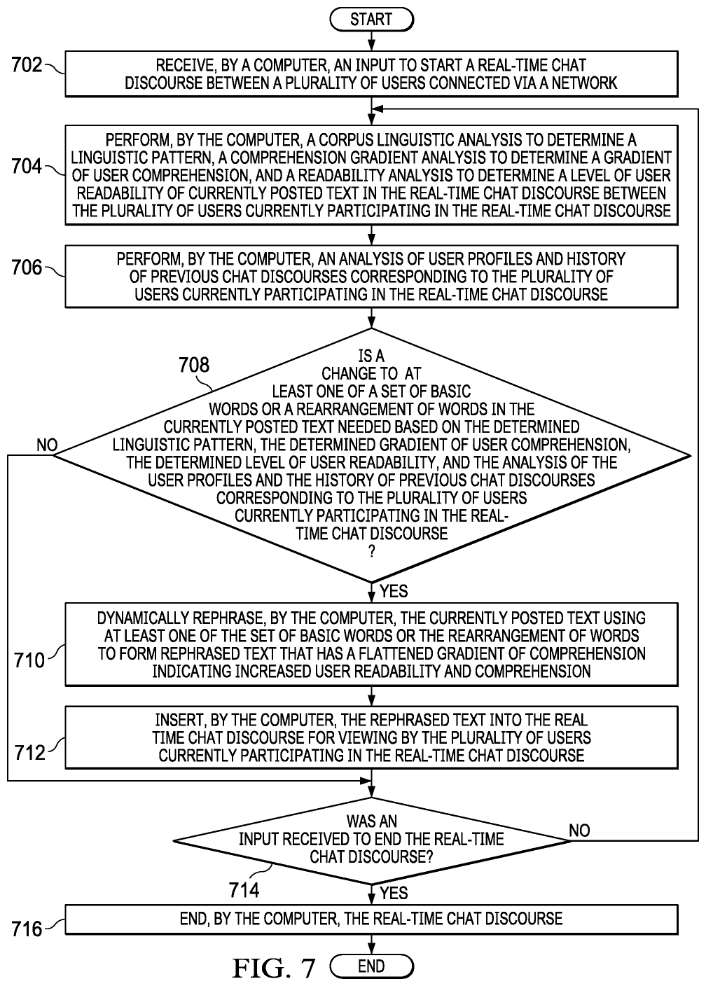

With reference now to FIG. 7, a flowchart illustrating a process for dynamic chat discourse rephrasing is shown in accordance with an illustrative embodiment. The process shown in FIG. 7 may be implemented in a computer, such as, for example, server 104 in FIG. 1 or data processing system 200 in FIG. 2. For example, the process shown in FIG. 7 may be implemented in discourse comprehension model 218 in FIG. 2.

The process begins when the computer receives an input to start a real-time chat discourse between a plurality of users connected via a network (step 702). In response to starting the real-time chat discourse, the computer performs a corpus linguistic analysis to determine a linguistic pattern, a comprehension gradient analysis to determine a gradient of user comprehension, and a readability analysis to determine a level of user readability of currently posted text in the real-time chat discourse between the plurality of users currently participating in the real-time chat discourse (step 704). In addition, the computer performs an analysis of user profiles and history of previous chat discourses corresponding to the plurality of users currently participating in the real-time chat discourse (step 706).

The computer makes a determination as to whether a change to at least one of a set of basic words or a rearrangement of words in the currently posted text is needed based on the determined linguistic pattern, the determined gradient of user comprehension, the determined level of user readability, and the analysis of the user profiles and the history of previous chat discourses corresponding to the plurality of users currently participating in the real-time chat discourse (step 708). The set of basic words is comprised of one or more fundamental, common, or readily understandable words associated with a current topic of discussion in the real-time chat discourse. If the computer determines that a change to the currently posted text is not needed based on the determined linguistic pattern, the determined gradient of user comprehension, the determined level of user readability, and the analysis of the user profiles and the history of previous chat discourses corresponding to the plurality of users currently participating in the real-time chat discourse, no output of step 708, then the process proceeds to step 712. If the computer determines that a change to at least one of a set of basic words or a rearrangement of words in the currently posted text is needed based on the determined linguistic pattern, the determined gradient of user comprehension, the determined level of user readability, and the analysis of the user profiles and the history of previous chat discourses corresponding to the plurality of users currently participating in the real-time chat discourse, yes output of step 708, then the computer dynamically rephrases the currently posted text using at least one of the set of basic words or the rearrangement of words to form rephrased text that has a flattened gradient of comprehension indicating increased user readability and comprehension (step 710). Afterward, the computer inserts the rephrased text into the real-time chat discourse for viewing by the plurality of users currently participating in the real-time chat discourse (step 712).

Subsequently, the computer makes a determination as to whether an input was received to end the real-time chat discourse (step 714). If the computer determines that an input was not received to end the real-time chat discourse, no output of step 714, then the process returns to step 704 where the computer continues to perform analyses corresponding to the real-time chat discourse. If the computer determines that an input was received to end the real-time chat discourse, yes output of step 714, then the computer ends the real-time chat discourse (step 716) and the process terminates thereafter.

Thus, illustrative embodiments of the present invention provide a computer-implemented method, computer system, and computer program product for applying a discourse comprehension model to text of a real-time chat discourse to rephrase a set of the text during the real-time chat discourse for decreased time-based user readability and increased user comprehension of the rephrased set of text by a particular user or group of users participating in the real-time chat discourse. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for dynamic chat discourse rephrasing, the computer-implemented method comprising:
performing, by a computer, an analysis of a real-time chat discourse conducted between a plurality of users connected via a network;
generating, by the computer, a discourse comprehension model based on the analysis of the real-time chat discourse; and
rephrasing, by the computer, a set of text in the real-time chat discourse to decrease user time to comprehend the set of text using the discourse comprehension model.

2. The computer-implemented method of claim 1 further comprising:
customizing, by the computer, the discourse comprehension model on a per chat discourse channel and temporal basis using machine learning.

3. The computer-implemented method of claim 1 further comprising:
performing, by the computer, a corpus linguistic analysis to determine a linguistic pattern, a comprehension gradient analysis to determine a gradient of user comprehension, and a readability analysis to determine a level of user readability in currently posted text in the real-time chat discourse between the plurality of users currently participating in the real-time chat discourse;
determining, by the computer, whether a change to at least one of a set of basic words or a rearrangement of words in the currently posted text is needed based on determined linguistic pattern, determined gradient of user comprehension, and determined level of user readability; and
rephrasing, by the computer, the currently posted text using at least one of the set of basic words or the rearrangement of words to form rephrased text that has a flattened gradient of comprehension indicating increased user readability and comprehension in response to determining that the change to at least one of the set of basic words or the rearrangement of words in the currently posted text is needed.

4. The computer-implemented method of claim 3 further comprising:
inserting, by the computer, the rephrased text into the real-time chat discourse for viewing by the plurality of users currently participating in the real-time chat discourse.

5. The computer-implemented method of claim 3 further comprising:
performing, by the computer, an analysis of user profiles and history of previous chat discourses corresponding to the plurality of users currently participating in the real-time chat discourse; and
determining, by the computer, whether the change to at least one of the set of basic words or the rearrangement of words in the currently posted text is needed based on the determined linguistic pattern, the determined gradient of user comprehension, the determined level of user readability, and the analysis of the user profiles and the history of previous chat discourses corresponding to the plurality of users currently participating in the real-time chat discourse.

6. The computer-implemented method of claim 1, wherein the set of text of the real-time chat discourse is dynamically rephrased on at least one of a per chat discourse channel basis or a per chat discourse user group basis.

7. The computer-implemented method of claim 1, wherein the set of text of the real-time chat discourse is dynamically rephrased in accordance with a style used by the plurality of users to decrease complexity and increase user readability and understanding.

8. A computer system for dynamic chat discourse rephrasing, the computer system comprising:
a bus system;
a storage device connected to the bus system, wherein the storage device stores program instructions; and
a processor connected to the bus system, wherein the processor executes the program instructions to:
perform an analysis of a real-time chat discourse conducted between a plurality of users connected via a network;
generate a discourse comprehension model based on the analysis of the real-time chat discourse; and
rephrase a set of text in the real-time chat discourse to decrease user time to comprehend the set of text using the discourse comprehension model.

9. The computer system of claim 8, wherein the processor further executes the program instructions to:
customize the discourse comprehension model on a per chat discourse channel and temporal basis using machine learning.

10. The computer system of claim 8, wherein the processor further executes the program instructions to:
perform a corpus linguistic analysis to determine a linguistic pattern, a comprehension gradient analysis to determine a gradient of user comprehension, and a readability analysis to determine a level of user readability in currently posted text in the real-time chat discourse between the plurality of users currently participating in the real-time chat discourse;
determine whether a change to at least one of a set of basic words or a rearrangement of words in the currently posted text is needed based on determined linguistic pattern, determined gradient of user comprehension, and determined level of user readability; and
rephrase the currently posted text using at least one of the set of basic words or the rearrangement of words to form rephrased text that has a flattened gradient of comprehension indicating increased user readability and comprehension in response to determining that the change to at least one of the set of basic words or the rearrangement of words in the currently posted text is needed.

11. The computer system of claim 10, wherein the processor further executes the program instructions to:
insert the rephrased text into the real-time chat discourse for viewing by the plurality of users currently participating in the real-time chat discourse.

12. The computer system of claim 10, wherein the processor further executes the program instructions to:
perform an analysis of user profiles and history of previous chat discourses corresponding to the plurality of users currently participating in the real-time chat discourse; and
determine whether the change to at least one of the set of basic words or the rearrangement of words in the currently posted text is needed based on the determined linguistic pattern, the determined gradient of user comprehension, the determined level of user readability, and the analysis of the user profiles and the history of previous chat discourses corresponding to the plurality of users currently participating in the real-time chat discourse.

13. The computer system of claim 8, wherein the set of text of the real-time chat discourse is dynamically rephrased on at least one of a per chat discourse channel basis or a per chat discourse user group basis.

14. A computer program product for dynamic chat discourse rephrasing, the computer program product comprising a computer-readable storage medium having program instructions embodied therewith, the program instructions executable by a computer to cause the computer to perform a method of:
performing, by the computer, an analysis of a real-time chat discourse conducted between a plurality of users connected via a network;
generating, by the computer, a discourse comprehension model based on the analysis of the real-time chat discourse; and
rephrasing, by the computer, a set of text in the real-time chat discourse to decrease user time to comprehend the set of text using the discourse comprehension model.

15. The computer program product of claim 14 further comprising:
customizing, by the computer, the discourse comprehension model on a per chat discourse channel and temporal basis using machine learning.

16. The computer program product of claim 14 further comprising:
performing, by the computer, a corpus linguistic analysis to determine a linguistic pattern, a comprehension gradient analysis to determine a gradient of user comprehension, and a readability analysis to determine a level of user readability in currently posted text in the real-time chat discourse between the plurality of users currently participating in the real-time chat discourse;
determining, by the computer, whether a change to at least one of a set of basic words or a rearrangement of words in the currently posted text is needed based on determined linguistic pattern, determined gradient of user comprehension, and determined level of user readability; and
rephrasing, by the computer, the currently posted text using at least one of the set of basic words or the rearrangement of words to form rephrased text that has a flattened gradient of comprehension indicating increased user readability and comprehension in response to determining that the change to at least one of the set of basic words or the rearrangement of words in the currently posted text is needed.

17. The computer program product of claim 16 further comprising:
inserting, by the computer, the rephrased text into the real-time chat discourse for viewing by the plurality of users currently participating in the real-time chat discourse.

18. The computer program product of claim 16 further comprising:
performing, by the computer, an analysis of user profiles and history of previous chat discourses corresponding to the plurality of users currently participating in the real-time chat discourse; and
determining, by the computer, whether the change to at least one of the set of basic words or the rearrangement of words in the currently posted text is needed based on the determined linguistic pattern, the determined gradient of user comprehension, the determined level of user readability, and the analysis of the user profiles and the history of previous chat discourses corresponding to the plurality of users currently participating in the real-time chat discourse.

19. The computer program product of claim 14, wherein the set of text of the real-time chat discourse is dynamically rephrased on at least one of a per chat discourse channel basis or a per chat discourse user group basis.

20. The computer program product of claim 14, wherein the set of text of the real-time chat discourse is dynamically rephrased in accordance with a style used by the plurality of users to decrease complexity and increase user readability and understanding.
